(19) United States
(12) Patent Application Publication
(10) Pub. No.: US 2005/0097373 A1
(43) Pub. Date: May 5, 2005

(54) Automated intelligent configuration tool for power system protection and control and monitoring devices

(75) Inventors: James Stoupis, Raleigh, NC (US); Juan Macias, Lake Mary, FL (US); Kornel Scherrer, Oberwil-Lleli (CH); David Lubkeman, Cary, NC (US)

Correspondence Address: WOMBLE CARLYLE SANDRIDGE & RICE, P.O Box 7037, Atlanta, GA, 30357-0037, US

(73) Assignee: ABB Research, Ltd

(21) Appl. No.: 10/699,920

(22) Filed: Nov. 3, 2003

(51) Int. Cl. G06F 1/26

(52) U.S. Cl. 713/300

(57) ABSTRACT

An automatic configuration tool for use with power protection and restoration devices such as reclosers and switches in power transmission and distribution systems. An automatic configuration application provides a plurality of menus to a user on a graphical user interface to enable the user to select a plurality of options that are processed by various calculation engines to determine the configuration settings for a specific power protection and restoration device. The configuration settings that are generated are downloaded directly into the power protection and restoration device to provide protection, control and monitoring.

### FIELD OF THE INVENTION

The present invention relates generally to power systems, and more particularly, to configuration of automatic power protection and restoration devices for use in power transmission and distribution systems.

### BACKGROUND OF THE INVENTION

The reclosers and switches currently used for outdoor power systems include sophisticated protection and control electronics that need to be configured extensively for specific customer applications. Large utilities maintain a small number of application engineering experts that have the knowledge and expertise to configure these devices. However, a large number of potential customers, such as small municipal utilities or co-ops, do not have the requisite knowledge and capability to configure such sophisticated devices. Therefore, small utilities and co-ops are very reluctant to introduce more sophisticated power system applications for improving their services. Large utilities may also experience the same problem.

As an example of the types of problems experienced in the power system industry, consider the knowledge required to configure a device for feeder automation. Even for the larger utility customers, the range of features available for feeder automation communications and protection is nearly overwhelming. Many power protection engineers do not have the knowledge needed to properly configure the newer communication schemes available for feeder automation. Furthermore, many of the protection and monitoring functions are not applied, since users do not know how to set them up.

In the past, distribution protection devices, such as hydraulic reclosers, were fairly simple to set up. With today's more sophisticated feeder automation systems, utilities now need to have expertise in the areas of distribution protection, operations and communications. As utilities continue to cut costs and as experienced engineers retire, more of the functions typically performed by more experienced engineers have been delegated to entry-level engineers and technicians. Another problem is that the functionality of the intelligent electronic devices in current use is not well known by the engineer responsible for its settings. These additional capabilities were not available in the older mechanical reclosers. This results in an underutilization of the capabilities of such devices.

The existing method for setting a protection device involves a utility engineer determining the appropriate protection curve settings for each device on a distribution feeder, the engineer entering those settings into a settings software tool, and downloading the settings to each respective intelligent electronic device (IED) on the distribution feeder. The utility engineer can use a separate software tool to graphically plot the protection curves for more efficient coordination.

An IED is a microprocessor-based electronic device that is capable of sending control signals to switching devices, such as circuit breakers, reclosers, and switches in power systems, both on the distribution network and the transmission network. Most IEDs in use today combine control, monitoring, protection, reclosing elements, communications, power quality monitoring, and metering capabilities. The protection functions supported by IEDs include time delay and instantaneous over-current functions for phase and ground elements, sequence directional over-current functions, reclosing functions, over- and under-frequency protection functions, and over- and under-voltage protection functions. The IEDs also support various metering functions; monitoring of voltage sags, swells, and interruptions; fault location algorithms; and oscillographic record storage. Most IEDs are configured locally using the front panel of the IED device or remotely using a settings software tool, which involves configuring hundreds of setting points individually.

### SUMMARY OF THE INVENTION

The present invention incorporates power system application knowledge in the form of an automated intelligent configuration tool for power protection and restoration device applications. A specific configuration is achieved by answering a number of relatively basic questions through a graphical user interface. Thus, the configuration of a product is more of an interview style as opposed to the configuration of dozens, if not hundreds, of single parameter values in a settings tool. The automated intelligent configuration tool outputs a settings file that can be downloaded directly into the protection and control equipment. Expert users are still able to use the traditional settings tool to tweak or customize equipment configurations.

In an exemplary embodiment, the automated intelligent configuration tool includes a processor, a memory for storing a plurality of databases, a graphical user interface, and an automatic configuration application that operates on the processor and provides a plurality of interactive menus to a user on the graphical user interface to enable the user to select a plurality of options that are processed to determine and export a plurality of configuration settings for a specific power protection and restoration device.

### BRIEF DESCRIPTION OF THE DRAWINGS

These and other advantages and aspects of the present invention will become apparent and more readily appreciated from the following detailed description of the presently preferred exemplary embodiments of the invention taken in conjunction with the accompanying drawings, of which:

FIG. 1 illustrates an exemplary looped feeder system in which the present invention is operable.

FIG. 2 illustrates an overview of the process for downloading settings to an intelligent electronic device using the intelligent configuration tool of the present invention.

FIG. 3 illustrates an exemplary screen display for setting of communications parameters.

FIG. 4 illustrates the system architecture of the present invention including the intelligent configuration tool and the settings software tools associated with each intelligent electronic device.

FIG. 5 illustrates the functional components of the intelligent configuration tool.

FIG. 6 illustrates the core modular components of the intelligent configuration tool.

FIG. 7 illustrates an exemplary process for entering general application information.

FIG. 8 illustrates an exemplary process for entering configuration settings information.

FIG. 9 illustrates an exemplary process for entering protection settings information.

FIG. 10 illustrates an exemplary process for entering communication settings information.

FIG. 11 illustrates an exemplary process for entering monitoring settings information.

FIG. 12 illustrates an exemplary process for entering programmable input/output settings information.

FIG. 13 illustrates an exemplary process for entering oscillographic settings information.

FIG. 14 illustrates an exemplary menu system for manually entering multiple parameter values into an intelligent electronic device.

### DETAILED DESCRIPTION OF THE INVENTION

The following description of the invention is provided as an enabling teaching of the invention and its best, currently known embodiment. Those skilled in the art will recognize that many changes can be made to the embodiments described while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations of the invention are possible and may even be desirable in certain circumstances and are part of the present invention. Thus, the following description is provided as illustrative of the principles of the invention and not in limitation thereof since the scope of the present invention is defined by the claims.

Various figures show different aspects of the system, and, where appropriate, reference numerals illustrating like components in different figures are labeled similarly. It is understood that various combinations of components other than those specifically shown are contemplated. Further, separate components are at times described with reference to a particular system embodiment, and while such description is accurate, it is understood that these components, with the variants described, are independently significant and have patentable features that are described separate and apart from the system in which they are described.

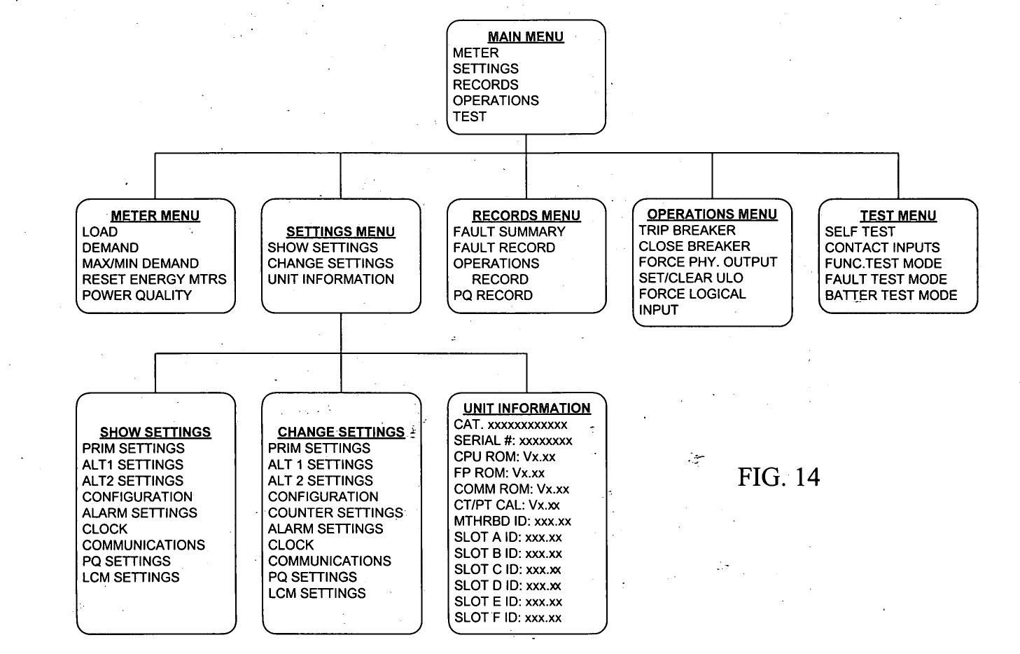

Switchgear product manufacturers can provide microprocessor-based control IEDs with electronic recloser equipment. The IED can then operate as a recloser controller. Acting as a recloser controller, the IED provides the intelligence that enables a recloser to sense overcurrents, select timing operations and time the tripping and reclosing functions. The IED combines control, monitoring, protection, reclosing elements, communications, power quality monitoring and metering capabilities. In general, configuring each IED involves the setting of hundreds of points, followed by downloading of these setting points to each device via a communications connection. Such devices need to be programmed to coordinate in a predefined manner to ensure that power systems respond to line faults in an expected manner. FIG. 14 shows an exemplary menu system for manually entering multiple parameter values into an IED. In this example, the settings menu includes at least three submenus: show settings, change settings and unit information. On a power systems network, the IEDs send trip and close signals to medium-voltage reclosers and switches based on the network voltage and current conditions.

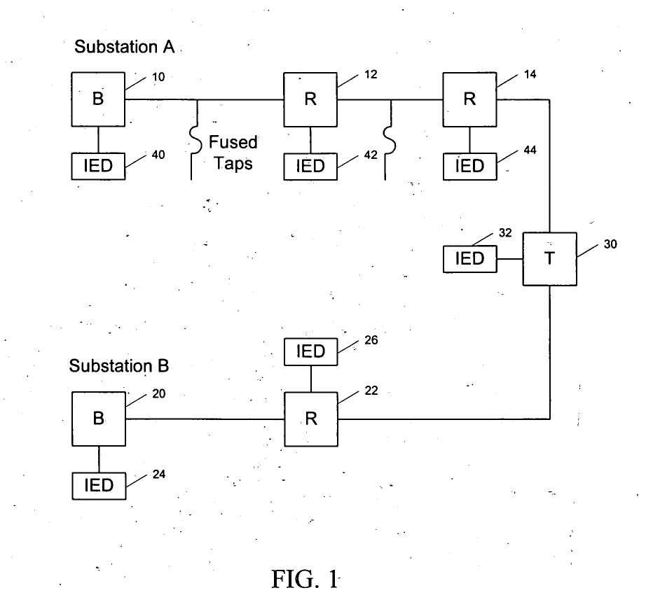

FIG. 1 illustrates an exemplary looped feeder system for a power distribution network. Shown in the figure are Substation A having circuit breaker 10, reclosers 12, 14 and IEDs 40, 42, 44. Substation B has circuit breaker 20, recloser 22 and IEDs 24, 26. The substations are connected by tiepoint recloser or switch 30 that has IED 32. For looped or radial distribution systems, the IEDs must coordinate their operation between each other, and with fuses in some cases, to ensure that the recloser closest to a fault operates first to clear the fault. For a looped system, the tiepoint IED 32 must coordinate with the other IEDs in order to restore service to unaffected customers.

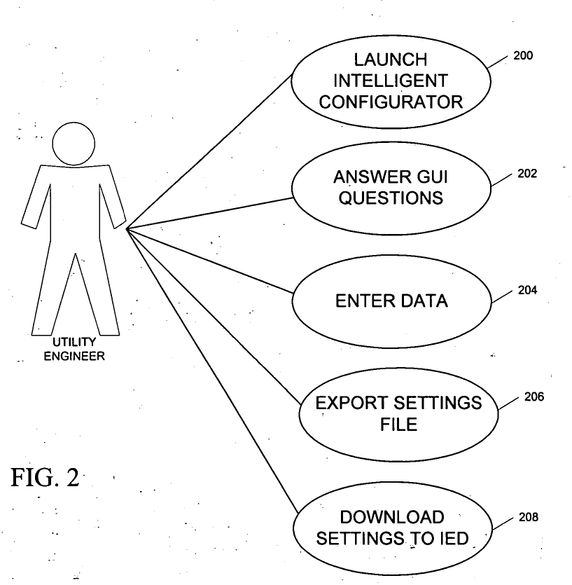

The purpose of the automated intelligent configuration tool is to provide a user-friendly graphical user interface, which displays questions to the user configuring a device and requests the user to input information in certain fields on the graphical display. Once all the pertinent information has been gathered, the intelligent configuration tool processes the information that is input and outputs a configuration file to be exported to the settings software tool. FIG. 2 provides a high-level overview of the process. The utility engineer launches the intelligent configuration tool in step 200. The utility engineer is then presented with a series of questions regarding power protection and restoration devices via a graphical user interface in step 202. The questions asked of the user pertain to system-related areas, such as the layout of the power distribution system, or the number or types of customers connected to each feeder. The power distribution system layout identifies whether the system is radial or looped, the number of reclosers and switches on each feeder and the types of fuses used. The engineer enters data via the GUI in step 204. The answers to the questions result in the protection settings for all devices on each feeder. The settings file is then exported to the IED in step 206. The settings are downloaded to the IED in step 208.

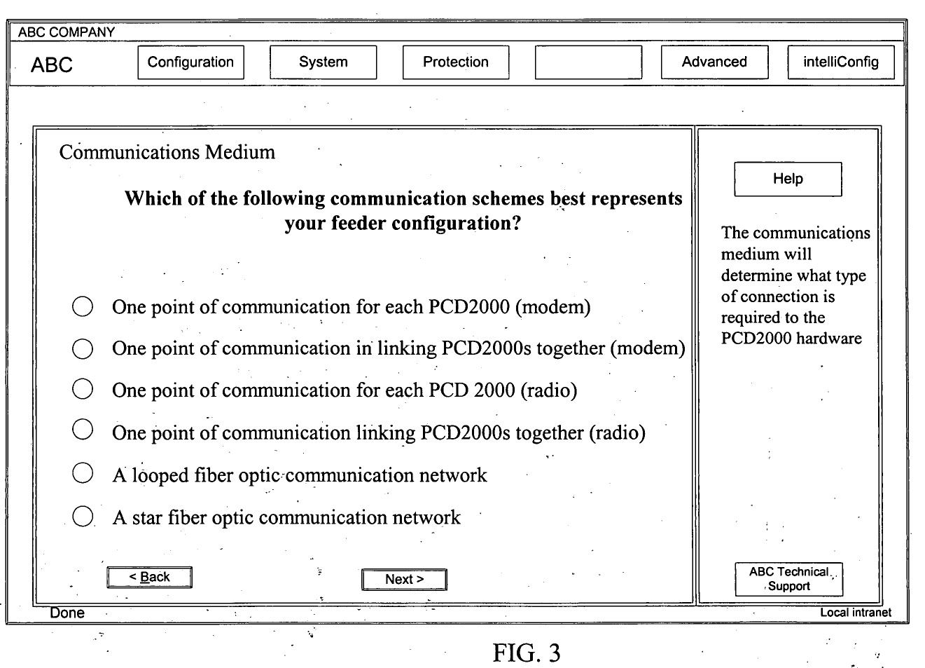

FIG. 3 illustrates an exemplary user interface screen for setting communications in an intelligent electronic device. The purpose of the particular screen depicted is to select the communications medium that will determine the type of connection required to connect to the IED hardware. The IED referred to in this example is available from ABB, Inc. Available options include one point of communication for each IED via modem or radio, frequency (wireless), one point of communication in linking multiple IEDs together via modem or radio frequency, a looped fiber optic communication network and a star fiber optic communication network.

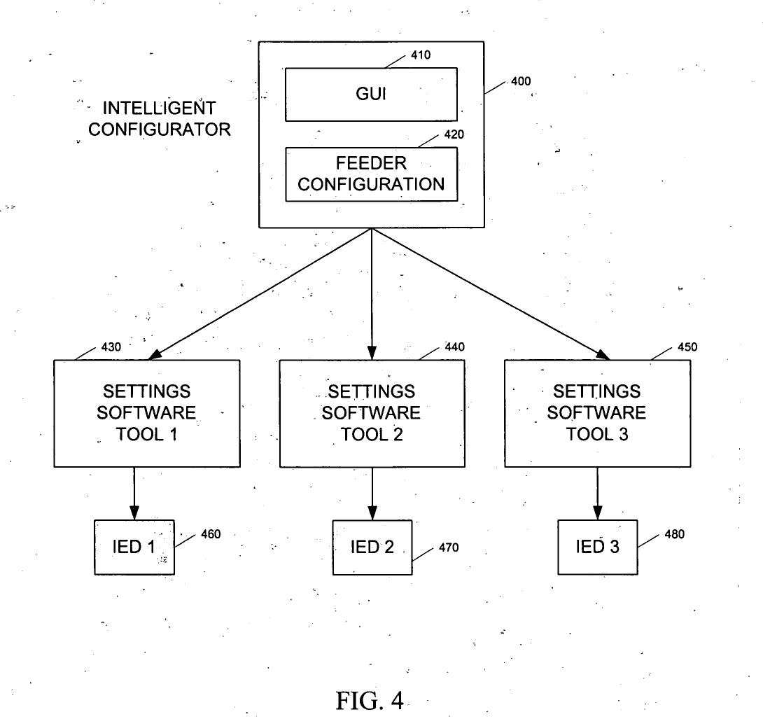

The automated intelligent configuration tool is a stand-alone, knowledge-based software application that can be installed on a standard PC. It uses web-based technologies to display questions to the user and to display fields requiring user input. The settings software tool then displays the settings to the user and transmits these settings in a web-based output file (i.e., XML file) to the IED. FIG. 4 shows the complete system architecture including the intelligent configuration tool 400, the settings software tools 430, 440, 450, and the IEDs 460, 470, 480. The intelligent configuration tool 400 includes a graphical user interface (GUI) 410 and a feeder configuration component 420. The intelligent configuration tool 400 is compatible with settings software tools 430, 440, 450 for several IEDs 460, 470, 480, respectively, as shown in the figures.

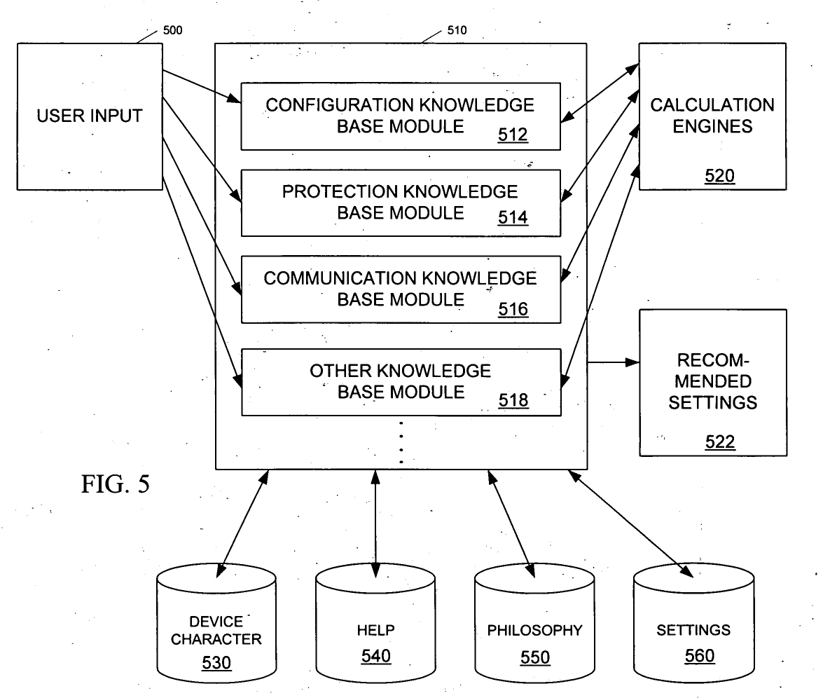

FIG. 5 shows the components of the configuration tool. The automated intelligent configuration tool includes an expert system 510 with knowledge-based rules that are applied to the inputs 500 entered by the user. The intelligent configuration tool contains knowledge-based rule sets 512, 514, 516, 518, databases 530, 540, 550, 560, and calculation engines 520, used to set communications, protective coordination, etc., and whose GUI screens change based on user input 500. The knowledge-based modules 512, 514, 516, 518 receive the inputs, follow the rules set in the knowledge-based modules by accessing the databases 530, 540, 550 560 and calculation engines 520, and generates a Web-based output settings file 522.

The calculation engines 520 include a plurality of engines such as a protection coordination engine, a coordination simulator engine and a programmable I/O mapping engine. The protection coordination engine determines which overcurrent protection curves and settings should be programmed in a recloser controller. The protection coordination engine performs protection coordination between reclosers, fuses and multiple reclosers. Curve timing coordination is based on preset parameters. The coordination simulator engine shows the sequence of events that would occur with current protection settings for a specific fault current that is entered by the user. This provides a logical check on the protection settings. The programmable I/O mapping engine performs mapping operations for the user's inputs to configure the programmable logic in the recloser controller for various functions such as hot line tagging and over-voltage trip and reclose. Additional calculation engines may be part of the configuration tool and are considered as part of the present invention.

The databases depicted in FIG. 5 include a device characteristic database 530, a protection philosophy attribute database 550, a settings information database 560, and a help information database 540. Other databases such as previously-entered user data can be a functional component of the intelligent configuration tool.

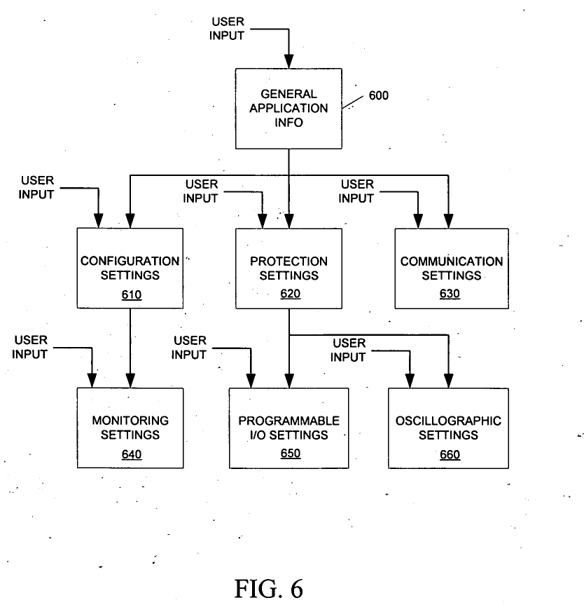

FIG. 6 illustrates the core modules in an exemplary embodiment of the intelligent configuration tool. The modules depicted are general application information 600, configuration settings 610, protection settings 620, communications settings 630, monitoring settings 640, programmable I/O settings 650 and oscillographic settings 660. The modules are arranged in a hierarchical order with the arrows indicating the order in which modules should be accessed, each module accepting user input directly. From the general application information module 600, the user can select and enter data into configuration settings module 610, protection settings module 620 or communications module 630. After entering data into the configuration settings module, the user can then enter data into the monitoring settings modules 640. From the protection settings module 620, the user can next input data into the programmable I/O settings module 650. From the protection settings module 620, the user can enter data into the oscillographic settings module 660. The data obtained from the user is stored in one of several databases. In some cases, data is stored based on input from one core module and later retrieved by a different core module. Once all modules have been completed by the user, a settings file 522 is generated with modified settings based on the user's inputs.

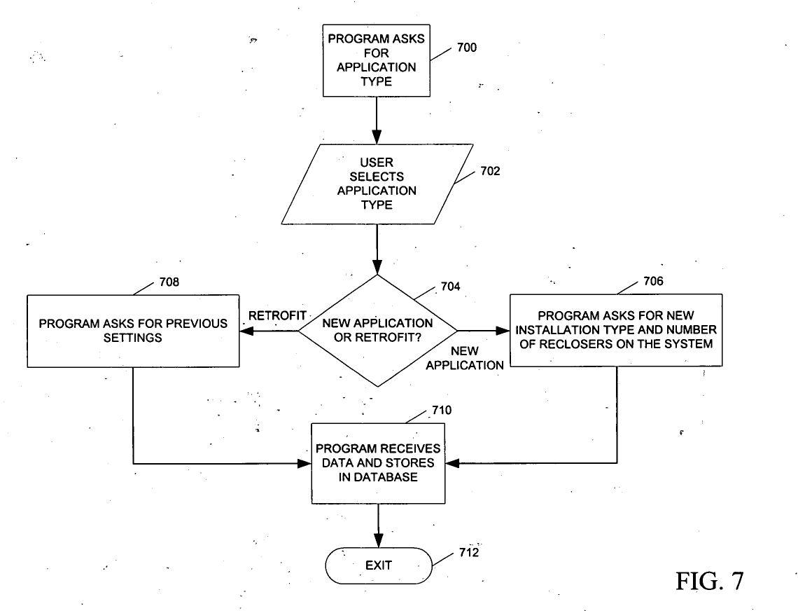

The general application information module 600 is a starting point for the intelligent configuration tool. It enables the user to select an application type, whether the application is a new installation or a retrofit to an existing installation. The intelligent configuration tool can support retrofits performed for existing reclosers from various vendors, as well as to set IEDs for new reclosers. FIG. 7 illustrates an exemplary process for entering general application information. Processing starts in logic block 700 with the general application module requesting the user to enter an application type. The user selects an application type as indicated in input block 702. The general application module then determines if the application type is a new installation or a retrofit to an existing installation as indicated in decision block 704. If it is a new application, the general application module asks for a new installation type (e.g., radial feeder or radial substation installation) and the number of reclosers in the system, as indicated in logic block 706. If the application type is retrofit for an existing installation, then the general application module asks for previous settings for the recloser controller, as indicated in logic block 708; From either logic block 706 or logic block 708, the general application module then receives data and stores it in a database as indicated in logic block 710. Processing exits from the general application module in termination block 712 and proceeds to the next module.

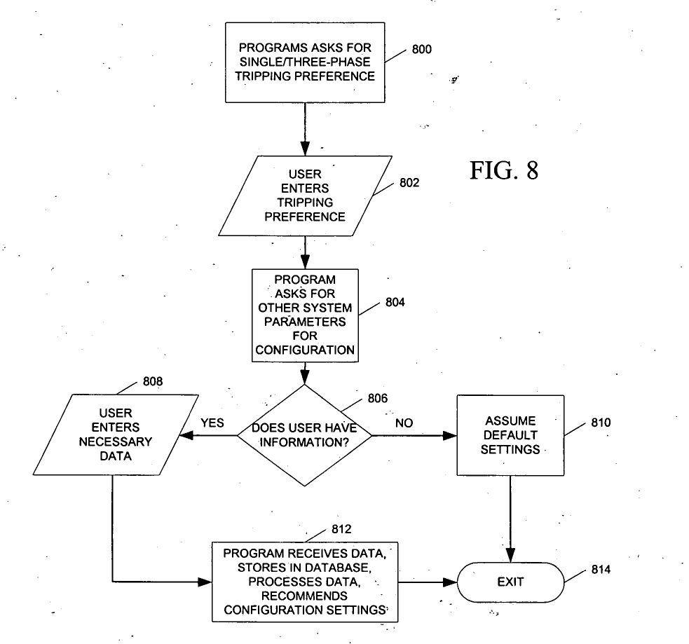

One of the modules that can be entered from the general application information module 600 is the configuration settings module 610. FIG. 8 illustrates an exemplary process for entering configuration settings information using the configuration settings module. The process starts in logic block 800 with the configuration settings module asking the user for single or three-phase tripping preference. Many small utilities have single-phase reclosers downstream from their reclosers or substation circuit breakers. Therefore, single-phase tripping is supported by the intelligent configuration tool. The user enters the tripping preference in input block 802. The configuration settings module then asks the user for other system parameters for configuration as indicated in logic block 804. Next, the configuration settings module determines if the user has other configuration setting information to enter in decision block 806. The user enters the necessary data in input block 808 if he has such information. In this step of entering necessary data regarding system parameters for configuration in input block 808, as an alternative, the user may be presented with a list of configuration options from which he can make a selection. Otherwise, the configuration settings module assumes the default settings as indicated in logic block 810. Following user input in input block 808, the configuration settings module receives the data input, stores it in a database, processes the data and recommends configuration settings as indicated in logic block 812. Whether configuration settings are recommended or default settings are assumed, processing then exits from the configuration settings module as indicated by termination block 814 and proceeds to the monitoring settings module 640.

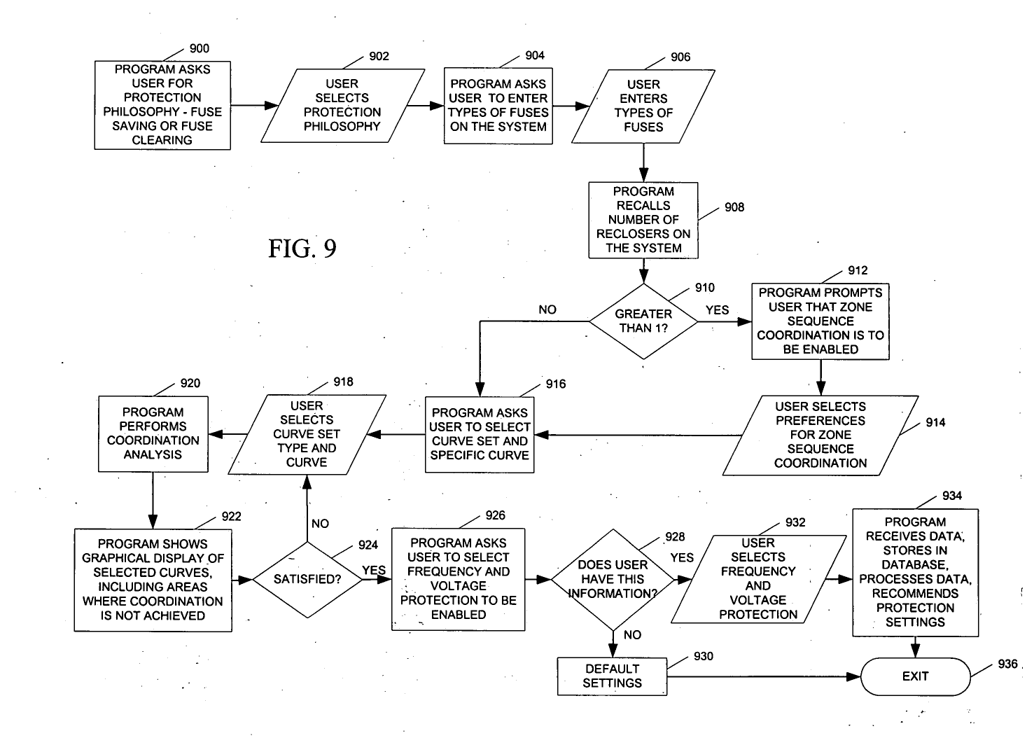

Another option available to the user after exiting the general application information module 600 is to enter protection settings via the protection settings module 620. FIG. 9 illustrates an exemplary process for entering protection settings information. Processing commences in logic block 900 with the protection settings module asking the user for a protection philosophy, i.e., fuse saving or fuse clearing. For fuse saving protection, any recloser on the system that is upstream from a fuse attempts to save the fuse by tripping quickly for the first two reclosing operations. If the fault is not cleared by the recloser, than the fuse attempts to isolate the fault. Fuse clearing is another protection philosophy. For this type of protection, any recloser on the system upstream from a fuse allows the downstream fuse to first clear the fault. If the fault is not cleared by the fuse, then a backup recloser isolates the fault. This module requires that the user know the protection philosophy to be followed, as well as information regarding fuses and types of protection functions to be enabled.

In input block 902, the user selects a protec tion philosophy in the user interface. In logic block 904, the protection settings module asks the user to enter types of fuses on the system. The user then enters the types of fuses in the user interface as indicated in input block 906. The protection settings module recalls the number of reclosers on the system as indicated in logic block 908. A determination is made in decision block 910 if the number of reclosers on the system is greater than one. If it is, the protection settings module then prompts the user that zone sequence coordination is to be enabled as indicated in logic block 912. The user selects preferences for zone sequence coordination in input block 914. If the number of reclosers on the system is not greater than one in decision block 910, or if the user selects preferences for zone sequence coordination in input block 914, processing continues in logic block 916 with the program settings module asking the user to select a protection curve set and a specific curve. The user then selects the protection curve set type and specific curve in input block 918. In operation, reclosers typically use two curves for protection: ANSI 50 and ANSI 51. These curves are referred to as slow and fast curves, respectively. These curves are coordinated with other protection devices on the circuit.

The protection coordination engine performs coordination analysis as indicated in logic block 920. Next, in logic block 922, the protection settings module shows the user a graphical display of selected curves, including areas where coordination is not achieved. In decision block 924, the protection settings module queries the user to determine if the user is satisfied with the coordination. If the user is not satisfied, processing returns to input block 918 to enable the user to select another protection curve set type and specific curve. Otherwise, the protection settings module asks the user to select frequency and voltage protection that are to be enabled in logic block 926. A test is made in logic block 928 to determine if the user has frequency and voltage protection information. If not, default settings are used as indicated in logic block 930 and processing exits in termination block 936 to the programmable I/O settings module 650. If the user does have frequency and voltage protection information, he selects the frequency and voltage protection via the user interface as indicated in input block 932. The protection settings module receives this data from the user, stores it in the database, processes the data, and recommends protection settings, as indicated in logic block 934. Processing exits in termination block 936 and proceeds to the programmable I/O settings module 650.

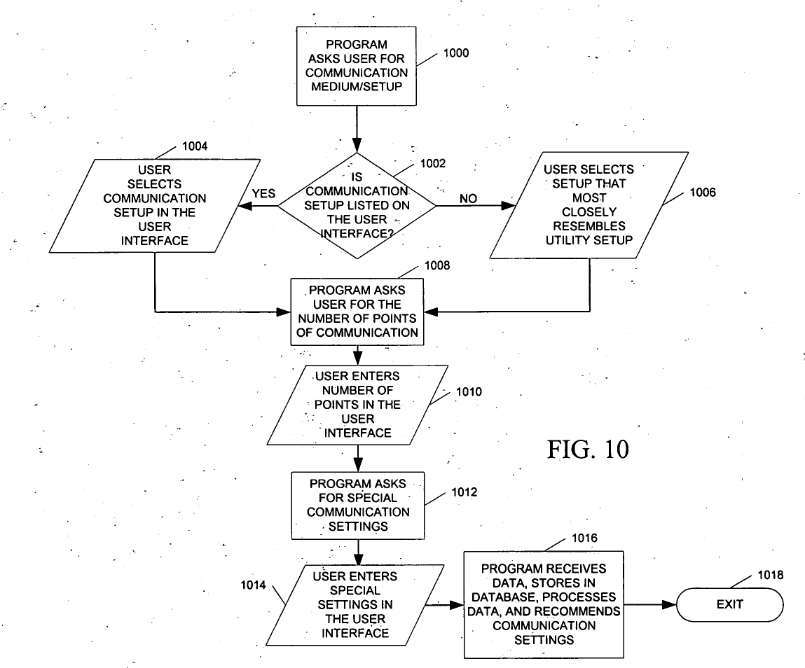

A third option for entering configuration information from the general application information module 600 is the communication setting module 630. FIG. 10 illustrates an exemplary process for entering communication settings information. Processing starts in logic block 1000 with the communication settings module asking the user for communication medium setup information. FIG. 3 depicts an exemplary user interface for this setup information. A determination is made in decision block 1002 if the communication setup is listed on the user interface. If it is, then the user selects a communication setup in the user interface as indicated in input block 1004, otherwise, the user selects a setup that most closely resembles the desired utility setup in input block 1006. From either input block 1004 or input block 1006, the communication settings module asks the user for the number of points of communication in logic block 1008. The user then enters the number of points of communication in the user interface in input block 1010. The communication settings module next asks the user for any special communications settings in logic block 1012. The user enters any special settings in the user interface as indicated in input block 1014. The communication settings module receives this data, stores it in a database, processes it and recommends communication settings as indicated in logic block 1016. Processing then exits in termination block 1018.

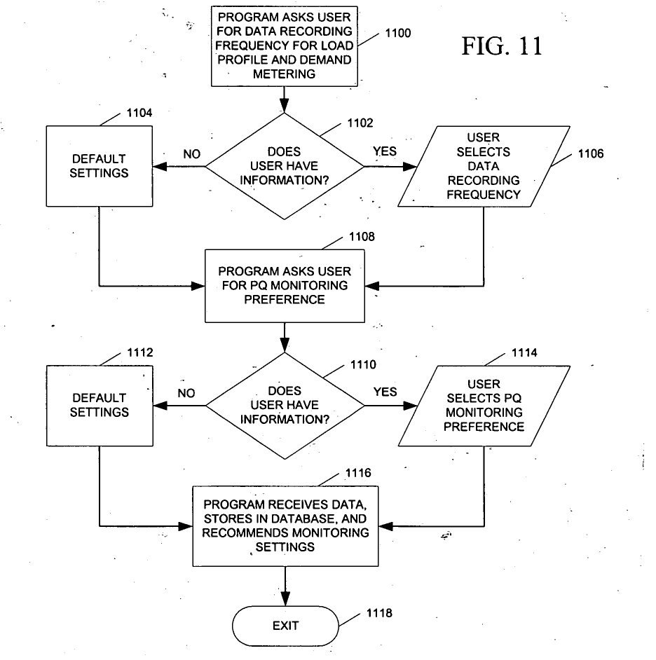

Once the user exits the configuration settings module 610, he, can proceed with entering monitoring settings via the monitoring settings module 640. FIG. 11 illustrates an exemplary process for entering monitoring settings information. Processing begins in logic block 1100 with the monitoring settings module asking the user for data recording frequency for load profile and demand metering. The load profile allows the user to view the load current levels during a specific time interval. Demand metering allows the user to view the demand current levels during a specific time interval. By accumulating this data, the user is able to view any trends in load and demand current levels. This module also enables a user to configure a recloser controller for power quality (PQ) monitoring. Power quality monitoring allows a user to view data related to any short-term or long-term voltage disturbances on the system, such as sags, swells, interruptions, and over/under voltage conditions. In decision block 1102, the monitoring settings module determines if the user has data recording frequency information to enter. If he does not, then in logic block 1104, the monitoring settings module uses default settings. Otherwise, the user selects data recording frequency via the user interface as indicated in input block 1106. The monitoring settings module asks the user for power quality monitoring preference in logic block 1108. In decision block 1110, a determination is made if a user has a PQ monitoring preference. If he does not, then default settings are used as indicated in logic block 1112. Otherwise, the user selects a PQ monitoring preference via the user interface as indicated in input block 1114. From either logic block 1112 or input block 1114, the monitoring settings module receives the data, stores it in a database, and recommends monitoring settings as indicated in logic block 1116. Processing exits the monitoring settings module in termination block 1118.

From the protection settings module 620, the user can proceed to the programmable I/O settings module 650. This module enables the user to configure the programmable logic for various functions, such as, but not limited to, hot line tagging, blown fuse indication, over-voltage trip and reclose, user LEDs, and cold load pickup. The hot line tag application involves setting a, recloser in one-shot mode and preventing all sources of closing. The hot line tag application requires that the source that tagged the control also un-tags the control. The hotline tag application is used for both looped and radial applications. A blown fuse indication can be detected by a recloser IED when it is used as a downstream protection device for a primary side blown fuse. The logic is programmed to determine when a single-phase, under-voltage condition is observed at the same time that a three-phase under voltage condition is not present. The over-voltage trip and reclose application involves tripping the recloser during an over-voltage condition, changing to alternate settings, and subsequently determining when the voltage has dropped down to normal levels. Once the voltage has returned to normal, the recloser is allowed to reclose. Some recloser IEDs support the mapping of outputs to user LEDs that are available on the front panel of the IED. The intelligent configuration tool supports the mapping of outputs to the LEDs available on the front panel. Cold load time is used to block unintentional tripping of protection elements due to in-rush currents after the recloser has been opened for a specified period. The cold load time logical output can be mapped to a physical output.

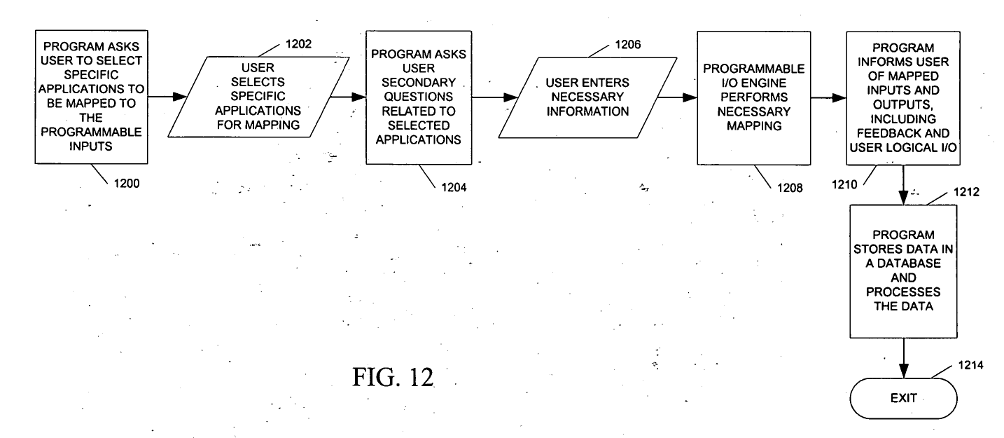

FIG. 12 illustrates an exemplary process for entering programmable input/output settings information. Processing starts in logic block 1200 with the programmable I/O settings module asking the user to select specific applications to be mapped to the programmable inputs. The user selects specific applications for mapping via the user interface as indicated in input block 1202. Next, the programmable I/O settings module asks the user secondary questions related to selected applications for mapping as indicated in logic block 1204. The user then enters the requested information as indicated in input block 1206. The programmable I/O engine performs the necessary mapping as indicated in logic block 1208. The programmable I/O settings module informs the user of the mapped inputs and outputs, including feedback and user logical I/O as indicated in logic block 1210. The programmable I/O settings module then stores this data in a database and processes data as indicated in logic block 1212. The programmable I/O settings module is then exited as indicated in termination block 1214.

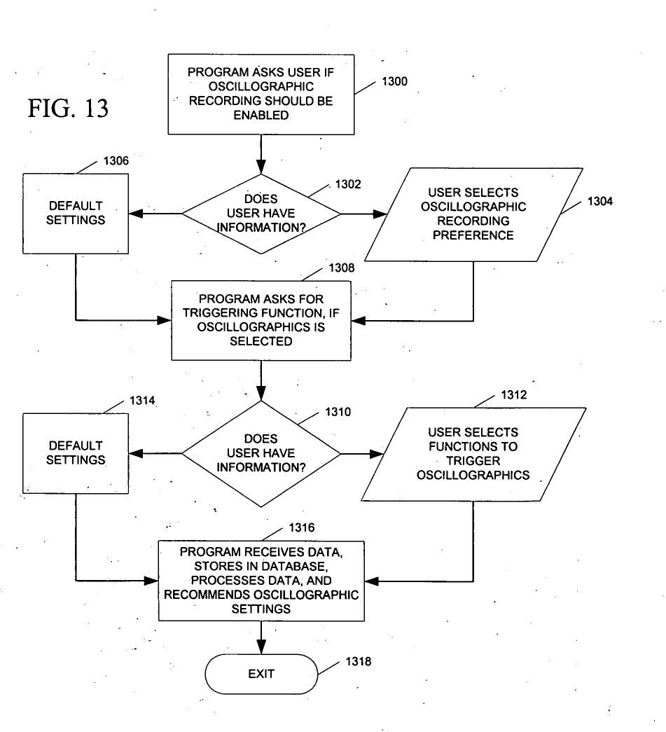

The user can also proceed to the oscillographic settings module 660 from the protection settings module 620. Waveform capture is useful to utilities when a fault or disturbance occurs on the system. The fault and disturbance data can be viewed and analyzed by a utility engineer by using the waveform capture feature of recloser controllers. FIG. 13 illustrates an exemplary process for entering oscillographic settings information. This module enables the user to select functions for triggering oscillographic recording individually or by selecting a class of functions. For example, the user can select a trigger position for oscillographic recording pertaining to over-current protection functions, PQ monitoring functions, etc. Processing starts in logic block 1300 with the oscillographic settings module asking the user if oscillographic recording should be enabled. In decision block 1302, a determination is made whether the user has oscillographic recording preferences. If he does not, then default settings are used as indicated in logic block 1306. Otherwise, the user selects oscillographic recording preferences via the user interface, as indicated in input block 1304. The oscillographic settings module then asks for triggering functions for oscillographic recording in logic block 1308. In decision block 1310, a determination is made whether the user knows which functions are to trigger oscillographic recording. If the user does not have this information, default settings are used, as indicated in logic block 1314. If the user does know which functions are to trigger oscillographic recording, he selects those functions via the user interface as indicated by input block 1312. The oscillographic settings module then receives the data, either user selected or default settings, stores data in a database, processes the data, and recommends oscillographic settings as indicated in logic block 1316. Processing exits from the oscillographic settings module in termination block 1318.

The present invention can be implemented in various power transmission or distribution system configurations. The techniques described may be implemented in software, or a combination of software and hardware. The program instructions can be implemented in assembly or machine code on any general purpose computing system including a visual display and an input device, such as a keyboard, touch screen, and mouse.

Those skilled in the art will appreciate that many modifications to the exemplary embodiment of the present invention are possible without departing from the spirit and scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

1. An automatic configuration tool for use with power protection and restoration devices, comprising:
a processor;
a memory for storing a plurality of databases;
a graphical user interface; and
an automatic configuration application operating on the processor to provide a plurality of menus to a user on the graphical user interface to enable the user to select a plurality of options that are processed to determine and export a plurality of configuration settings for a specific power protection and restoration device.

2. The automatic configuration tool of claim 1 wherein the automatic configuration application comprises a plurality of settings modules, a calculation engine and a power protection and restoration device settings file.

3. The automatic configuration tool of claim 2 wherein the plurality of settings modules comprises a general application module for enabling the use to select an application type for a power system installation.

4. The automatic configuration tool of claim 3 wherein the application type is selected for a power distribution installation.

5. The automatic configuration tool of claim 3 wherein the application type is selected for a power transmission installation.

6. The automatic configuration tool of claim 4 wherein the application type that the user can select for the distribution system installation is new or retrofit.

7. The automatic configuration tool of claim 2 wherein the plurality of settings modules comprises a configuration settings module that enables the user to select tripping preference and other parameters for the specific power protection and restoration device.

8. The automatic configuration tool of claim 7 wherein the tripping preference selection includes either single-phase or three-phase.

9. The automatic configuration tool of claim 2 wherein the plurality of settings modules comprises a protection settings module that enables the user to select at least one a protection philosophy preference, a zone sequence coordination preference and a protection curve.

10. The automatic configuration tool of claim 9 wherein the protection philosophy preference selection includes either fuse saving or fuse clearing.

11. The automatic configuration tool of claim 2 wherein the plurality of settings modules further comprises a communications settings module that enables the user to select a communications medium for the specific power protection and restoration device.

12. The automatic configuration tool of claim 2 wherein the plurality of settings modules further comprises a monitoring settings module that enables the user to select a data recording frequency for at least one of a load profile and a demand metering.

13. The automatic configuration tool of claim 12 wherein the monitoring settings modules enables the user to select a power quality monitoring preference.

14. The automatic configuration tool of claim 2 wherein the plurality of settings modules further comprises a programmable input/output settings module that enables the user to configure a plurality of programmable functions for the specific power protection and restoration device.

15. The automatic configuration tool of claim 14 wherein the plurality of programmable functions includes at least one of hot line tagging, a blown fuse indication, an overvoltage trip and reclose, and a cold load pickup.

16. The automatic configuration tool of claim 2 wherein the plurality of settings modules further comprises an oscillographic settings module that enables the user to select an oscillographic recording preference for the specific power protection and restoration device.

17. The automatic configuration tool of claim 16 wherein the oscillographic settings module enables the user to select a triggering function for enabling waveform capture of fault and disturbance data for the specific power protection and restoration device.

18. The automatic configuration tool of claim 2 wherein the calculation engine includes at least one of a protection coordination engine, a coordination simulator engine and a programmable input/output mapping engine.

19. The automatic configuration tool of claim 18 wherein the protection coordination engine determines an overcurrent protection curve and settings to be programmed into the specific power protection and restoration device.

20. The automatic configuration tool of claim 18 wherein the coordination simulator engine determines a sequence of events that would occur with a plurality of protection settings for a specific fault current.

21. The automatic configuration tool of claim 18 wherein the programmable input/output mapping engine enables the user to configure programmable logic in the specific power protection and restoration device for a plurality of functions.

22. The automatic configuration tool of claim 1 wherein the plurality of databases includes at least one of a protection philosophy database, a settings information database, a device characteristics database and a previously-entered selections database.

23. The automatic configuration tool of claim 2 wherein the automatic configuration application stores the plurality of determined configuration settings in the power protection and restoration device settings file.

24. The automatic configuration tool of claim 23 wherein the power protection and restoration device settings file is a web-based file.

25. The automatic configuration tool of claim 23 wherein the power protection and restoration device settings file is a XML file.

26. A method for automatically configuring a power protection and restoration device comprising the steps of:
generating a plurality of databases to store protection, control and monitoring information for power protection and restoration devices;
selecting a plurality of presented options interactively using a graphical user interface;
processing the selected plurality of options using a calculation engine to determine a plurality of protection, control and monitoring settings;
creating a protection, control and monitoring settings output file; and
automatically downloading the protection, control and monitoring settings output file to an intelligent electronic device for the power protection and restoration device.

27. The method for automatically configuring of claim 26 wherein the plurality of databases includes at least one of a settings information database, a device characteristics database, a protection philosophy database, and a previously-entered selections database.

28. The method for automatically configuring of claim 26 wherein the plurality of presented options includes at least one of configuration settings, protection settings, communication settings and monitoring settings.

29. The method for automatically configuring of claim 28 wherein the plurality of presented options further includes at least one of programmable input/output settings and oscillographic settings.

30. The method for automatically configuring of claim 28 wherein the configuration settings option enables a user to select a tripping preference and other configuration parameters for the power protection and restoration device.

31. The method for automatically configuring of claim 28 wherein the protection settings option enables a user to select at least one of a protection philosophy, a zone sequence coordination preference and a protection curve for the power protection and restoration device.

32. The method for automatically configuring of claim 28 wherein the communication settings option enable a user to select a communications medium for the power protection and restoration device.

33. The method for automatically configuring of claim 28 wherein the monitoring settings option enables a user to select a data recording frequency for at least one of a load profile and a demand metering.

34. The method for automatically configuring of claim 28 wherein the monitoring settings option enables a user to select a power quality monitoring preference.

35. The method for automatically configuring of claim 29 wherein the programmable input/output settings option enables a user to configure a plurality of programmable functions for the power protection and restoration device.

36. The method for automatically configuring of claim 29 wherein the oscillographic setting option enables a user to select an oscillographic recording preference for the power protection and restoration device.

37. The method for automatically configuring of claim 26 wherein the calculation engine determines an overcurrent protection curve and protection settings for the power protection and restoration device.

38. The method for automatically configuring of claim 26 wherein the calculation engine determines a sequence of events that would occur for a plurality of protection settings for a specific fault current.

39. The method for automatically configuring of claim 26 wherein the calculation engine performs mapping operations that enables a user to configure programmable logic for a plurality of functions for the power protection and restoration device.

40. A computer readable medium encoded with computer-executable instructions to perform the steps of:
storing protection, control and monitoring information for power protection and restoration devices in a plurality of databases;
enabling a user to select a plurality of presented options interactively using a graphical user interface;
processing the selected plurality of options to determine a plurality of protection, control and monitoring settings;
creating a protection, control and monitoring settings output file; and
automatically downloading the protection, control and monitoring settings output file to an intelligent electronic device for the power protection and restoration device.

41. The computer readable medium of claim 40 wherein the plurality of presented options includes at least one of configuration settings, protection settings, communication settings and monitoring settings.

42. The computer readable medium of claim 40 wherein the plurality of presented options includes at least one of programmable input/output settings and oscillographic settings.
